(19) United States
(12) Patent Application Publication
(10) Pub. No.: US 2009/0141021 A1
(43) Pub. Date: Jun. 4, 2009

(54) METHOD AND SYSTEM FOR PROVIDING EXPERIENTIAL KNOWLEDGE ASSOCIATED WITH SPATIAL AND TEMPORAL INFORMATION

(75) Inventors: Manjai LEE, Daejeon (KR); Seung Wook Lee, Daejeon (KR); Bon Ki Koo, Daejeon (KR); Kwang Ho Yang, Daejeon (KR); Ji Hyung Lee, Daejeon (KR); Heung-Nam Kim, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunication Research Institute, Daejeon (KR)

(21) Appl. No.: 12/275,760

(22) Filed: Nov. 21, 2008

(30) Foreign Application Priority Data
Nov. 22, 2007 (KR) 10-2007-0119551

(51) Int. Cl. G06T 15/00

(52) U.S. Cl. 345/419

(57) ABSTRACT

A method for providing knowledge includes creating a three-dimensional virtual space, generating temporal and spatial information including knowledge and space information concerning the three-dimensional virtual space at a specific time point, and associating the temporal and spatial information with the three-dimensional virtual space to be stored in a memory. The creating the three-dimensional virtual space may be created based on a map or a two-dimensional image.

### CROSS-REFERENCE (S) TO RELATED APPLICATIONS

The present invention claims priority of Korean Patent Application No. 10-2007-0119551, filed on Nov. 22, 2007, which is incorporated herein by reference.

### FIELD OF THE INVENTION

The present invention relates to a method and system for providing knowledge; and, more particularly, to the method and system capable of processing and visualizing time-varying information onto a three-dimensional virtual space to create stereographic knowledge and associate the stereographic knowledge with the virtual space, to share the same.

This work was supported by the IT R&D program of MIC/IITA. [2005-S-082-03, Development of Non-Photorealistic Animation Technology]

### BACKGROUND OF THE INVENTION

A map has conventionally used a space information concerning a real world. There are many services for providing information associated with the map, such as a car navigation system using a global positioning system (GPS), and a guide service using a map and a space information provided on the Internet. However, these map-based services provide only a two-dimensional view without a visual spatiality. The map services using satellite photographs, and 2.5 dimensional views which look like three-dimension, resulting from expansion of two-dimension have been attempted, but not overcome limitations.

The practical use of a virtual reality or computer graphics scheme has been conventionally attempted to provide the spatiality. An initial three-dimensional space is only a virtual world having no relation with a real world or only simulates the real world, but is not created equivalent to the real world. With the development of technologies, three-dimensional spaces for some regions have been recently created equivalent to the real world. However, the three-dimensional spaces created equivalent to the real world represent only the real world at a creation time point without considering a past or future figure of the world.

Information includes present information and past accumulated information so that information is geometrically increased over time. Conventional online knowledge search is based on a keyword search, but limited in acquiring information accumulated over time.

Accordingly, methods for processing information into knowledge have been widely used. One example of the methods is to visualize the information. Service for associating space information with knowledge is one example of visualization. On the other hand, temporal information is not yet associated with space information or knowledge in spite of importance thereof. Accordingly, there is a need for a method for associating space information, knowledge, and temporal information with one another.

In the present invention, a three-dimensional virtual space is created and time-varying space information is associated with the virtual space. This virtual space may reflect a real world as it is or may be created irrespective of the real world. Accordingly, the temporal information can be reflected to the virtual space since changed information obtained from past and present information, as well as the present information, can be processed, such that a static three-dimensional space can be dynamically managed over time. A reflection of temporal information to a space requires an association with the knowledge. The knowledge refers to past historical knowledge or information concerning present accumulated record and space.

A computing environment created dynamically over time may be used as a metaphor for knowledge search and experience by a user. In this environment, stereographic knowledge the user can experience in a virtual world may be created through visualization associated with knowledge. To maximize an experiential effect, a simulation such as weather simulation is performed so that the virtual space becomes more equivalent to the real world, and thereby reproducing present or past events using three-dimensional characters. When the user takes part in creation of the virtual space and accumulation of the knowledge, the knowledge share will be further activated. A virtual space associated with time, space, and knowledge is adapted so that a change within an ambient space in accordance with time can be simulated when a flow of time varies in a specific region.

### SUMMARY OF THE INVENTION

It is, therefore, an object of the present invention to provide a method and system capable of experimentally acquiring and sharing knowledge by processing and visualizing time-varying information onto a three-dimensional space to obtain stereographic knowledge created equivalent to, or irrespective of a real world.

In accordance with one aspect of the invention, there is provided a method for providing knowledge including creating a three-dimensional virtual space; generating temporal and spatial information including knowledge and space information concerning the three-dimensional virtual space at a specific time point; and associating the temporal and spatial information with the three-dimensional virtual space to be stored in a memory.

It is preferable that the method further includes allowing a user to access the virtual space and providing to a terminal the temporal and spatial information for an object selected in the virtual space by the user, wherein the virtual space and the temporal and spatial information are controlled with reference to a time axis.

It is also preferable that the creating the three-dimensional virtual space is created based on a map or a two-dimensional image.

It is desirable that the providing the temporal and spatial information provides a historical fact through a simulation.

It is preferred that the simulation is performed so that the three-dimensional virtual space varies with time in accordance with a time order selected by the user.

It is also preferred that the simulation provides the temporal and spatial information through a three-dimensional character.

It is preferable that the method further includes providing a user with access to the three-dimensional virtual space and providing a user terminal with an interface, with which the temporal and spatial information for an object selected in the virtual space is updated; and associating the updated temporal and spatial information with the three-dimensional virtual space to store the same in the memory.

In accordance with another aspect of the invention, there is provided a system for providing knowledge including a memory in which a three-dimensional virtual space and temporal and spatial information including knowledge and space information for the three-dimensional virtual space at a specific time point are associated to be stored; and a controller for controlling the associated three-dimensional virtual space and temporal and spatial information with reference to a time axis, providing a user with access to the three-dimensional virtual space and with the temporal and spatial information for an object selected by the user in the three-dimensional virtual space.

It is desirable that the three-dimensional virtual space stored in the memory is created based on a map or a two-dimensional image.

It is also desirable that the controller provides a historical fact through a simulation.

It is preferable that the controller performs the simulation so that the virtual space varies with time in accordance with a time order selected by the user.

It is also preferable that the controller provides the temporal and spatial information to the user through a three-dimensional character.

It is preferred that the system further includes a user terminal for updating the temporal and spatial information for the object selected by the user, wherein the memory updates and stores the temporal and spatial information input by the user.

It is also preferred that the system further includes an authoring tool for providing the user terminal with an interface, with which the user updates the temporal and spatial information.

It is desirable that an authoring tool for providing the user terminal with an interface, with which the user creates a new three-dimensional virtual space.

In accordance with the present invention, a threes dimensional virtual space is created using a three-dimensional scheme, and a time axis is newly associated with the space, so that past information and future information to be accumulated, as well as present information can be reflected to the space. This is used to visualize associated knowledge based thereon; to process the associated knowledge into stereoscopic information, not a simple text; and to acquire the knowledge experimentally. Further, the user is allowed to search for knowledge using the method which directly selects an object on a three-dimensional virtual space, other than keyword search, thereby easily obtaining desired knowledge.

As for a method and system for providing knowledge in accordance with the present invention, the three-dimensional virtual space can be created equivalent to or irrespective of the real world, such that the method and system may be applied to a digital home, an electronic commerce, a telematics, a digital broadcast, and an entertainment, as well as a knowledge industry.

### BRIEF DESCRIPTION OF THE DRAWINGS

The above and other objects and features of the present invention will become apparent from the following description of embodiments given in conjunction with the accompanying drawings, in which:

FIG. 1 depicts a block diagram illustrating a method for providing knowledge in accordance with the present invention;

FIG. 2 shows a flowchart representing a method for providing knowledge in accordance with an embodiment of the present invention;

FIG. 3 sets forth a flowchart showing a method for providing knowledge through a simulation in accordance with an embodiment of the present invention; and

FIG. 4 is a flowchart representing a method for sharing knowledge in accordance with an embodiment of the present invention.

### DETAILED DESCRIPTION OF THE PREFERRED EMBODIMENTS

In the present invention, a three-dimensional virtual space is created and time-varying space information is associated with the virtual space. Reflection of temporal information to a space requires association with the knowledge. The knowledge refers to past historical knowledge or present accumulated record and space information.

A computing environment created dynamically over time may be used as a metaphor for knowledge search and experience by a user. In this environment, stereographic knowledge the user can experience in a virtual world may be created through a visualization associated with knowledge. To maximize an experiential effect, a simulation such as a weather simulation can be performed so that the virtual space becomes more equivalent to the real world, and present or past events can be reproduced using three-dimensional characters. Further, the user may take part in virtual space creation and knowledge accumulation.

Thus, the present invention allows the user to experimentally acquire and share knowledge by processing and visualizing time-varying information, on a three-dimensional space to create the stereographic knowledge.

Hereinafter, a method and system for providing experiential knowledge associated with temporal and spatial information in accordance with the present invention will be described with reference to the accompanying drawings.

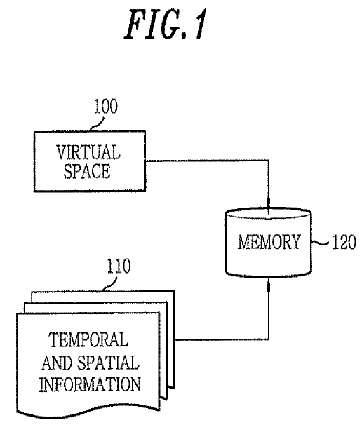

FIG. 1 depicts a block diagram illustrating a method for providing knowledge in accordance with the present invention.

The method for providing knowledge in accordance with the present invention is characterized in that time-varying information is reflected to a three-dimensional virtual space to be provided to a user stereographically. For this, a three-dimensional virtual space 100 is created using a three-dimensional stereographical scheme. Temporal and spatial information 110 such as space information, historical events, and knowledge at a specific time point about the virtual space is created. The created temporal and spatial information 110 is reflected to the three-dimensional virtual space, that is, the virtual space 100 is modeled to have its figure at a specific time point, such that the temporal and spatial information at a past time point, as well as the temporal and spatial information at a present time point, for the same space, is stored in a memory 120. Thus, a virtual space reflecting future temporal and spatial information with reference to the present time point can be created by continuously reflecting the temporal and spatial information at the past time point and the present time point and accumulated information for the same space to the present virtual space through time modeling.

This virtual space may be created to reflect the real world or, however, irrespective of the real world. The virtual space that has reflected the real world may serve to provide knowledge. The virtual space may be created based on a map or a two-dimensional image. The virtual space irrespective of the real world may also be utilized as spaces such as virtual sightseeing spaces, virtual department stores, and virtual cafes when the information and the knowledge are accumulated over time.

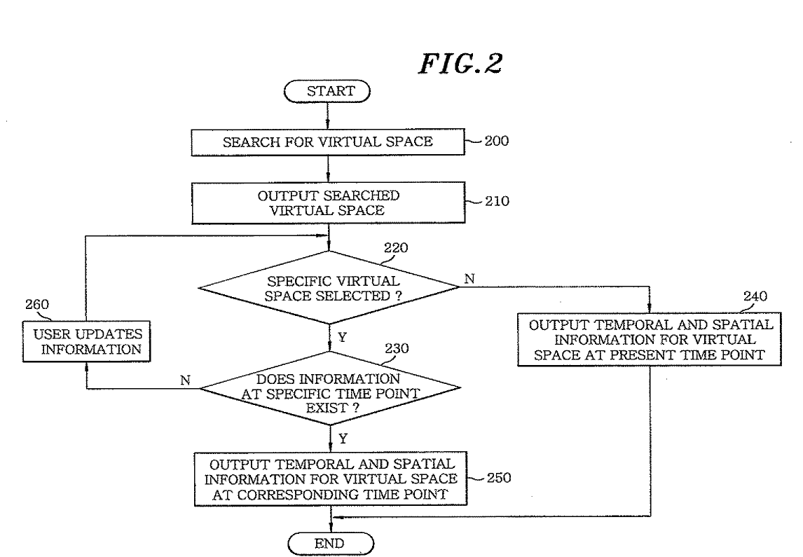

FIG. 2 shows a flowchart representing a method for providing knowledge in accordance with an embodiment of the present invention.

The temporal and spatial information is accumulated to the memory 120 as the method described above, and a user searches for a specific virtual space. The searched virtual space is outputted as a three-dimensional stereographical image to the user (S210). Basically, this virtual space outputs preferably a virtual space at a present time point. In case of acquiring a virtual space at a specific time point, and temporal and spatial information associated with space information and knowledge for the virtual space, in addition to the virtual space at the present time point, the user inputs the specific time point (S220). When there is information at the inputted specific time point (S230), the three-dimensional virtual space is converted to a space in accordance with the space information at the corresponding time point to be outputted (S250). Thereafter, the user can confirm desired information, such as the knowledge and historical events at the time point (S240 and S250). When there is no temporal and spatial information about the specific time point selected by the user, the user may select a specific time point again or update process of the temporal and spatial information may be performed as described below with reference to FIG. 4 (S260). That is, the step 260 is optional.

Thus, the method for providing knowledge allows the user to acquire not only information at a present time point but also information accumulated so for while confirming a figure at a specific time point, such that the user can stereographically acquire information at the specific time point as if he or she uses a time machine, based on a non-text, three-dimensional virtual space.

Preferably, a simulation such as a weather simulation may be performed and present or past events may be reproduced using three-dimensional characters in output steps 210, 240 and 250.

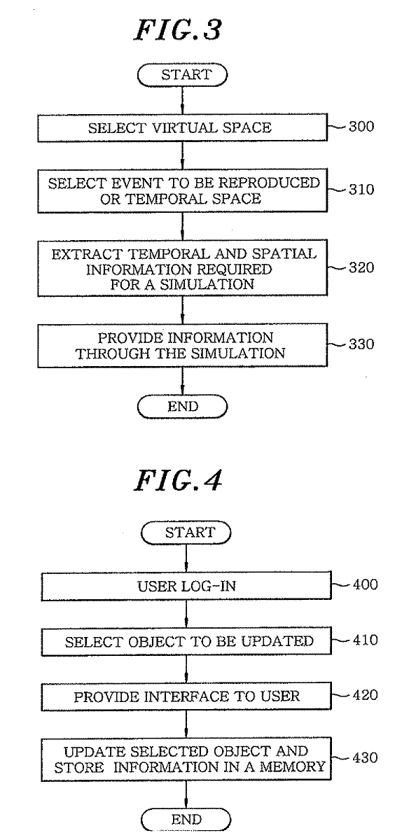

FIG. 3 sets forth a flowchart showing a method for providing knowledge through a simulation in accordance with an embodiment of the present invention.

A user selects a virtual space corresponding to a historical event to be simulated (S300). The user may then select an event occurred in the virtual space or a specific section of time, or select the virtual space by searching for the event to be simulated using a keyword (S310). That is, any search method used may allow the step 300 to be omitted and the step 310 to be directly performed in accordance with the search methods. Further, the temporal and spatial information required for simulation is then extracted from the memory (S320). The simulation on the three-dimensional virtual space is then performed, based on the extracted temporal and spatial information (S330). The simulation may be performed in a manner of reproducing historical events or visualizing a changing figure of the three-dimensional virtual space within the selected time section. This allows the user to search for the knowledge over time and space. Stereographic knowledge visualized in the virtual space can be acquired through experience above the dimension of simple knowledge acquisition.

Preferably, a simulation such as a weather simulation can be performed in response to a user's selection etc., and historical events may be reproduced or illustrated using three-dimensional characters.

FIG. 4 is a flowchart representing a method for sharing knowledge in accordance with an embodiment of the present invention.

A user accesses a system for providing knowledge in accordance with the present invention (S400), and selects an object to be updated (S410). The information the user updates may be the temporal and spatial information including knowledge concerning a previously created virtual space. The user may create, on the other hand, a virtual space itself, not created yet. Accordingly, an interface enabling the user to update or create a selected object is provided to the user (S420). The user can update temporal and spatial information for the virtual space or create a new virtual space, through the provided interface. The user then associates the virtual space with the temporal and spatial information and stores the same in the above-described memory (S430).

As described above, such an updating process may be performed even during the knowledge search. Accordingly, users may be provided with an authoring tool and cooperatively create a virtual space and share accumulated information, as well as a service provider creates a virtual space or accumulate knowledge and the user simply uses the knowledge. These characteristics in accordance with the present invention may be applied to various industries, as well as a knowledge industry. For example, they may be applied to virtual education through knowledge share or expanded to entertainment, such as virtual sightseeing using a virtual time machine.

While the invention has been shown and described with respect to the embodiments, it will be understood by those skilled in the art that various changes and modifications may be made without departing from the scope of the invention as defined in the following claims.

What is claimed is:

1. A method for providing knowledge comprising:
creating a three-dimensional virtual space;
generating temporal and spatial information including knowledge and space information concerning the three-dimensional virtual space at a specific time point; and
associating the temporal and spatial information with the three-dimensional virtual space to be stored in a memory.

2. The method of claim 1, further comprising allowing a user to access the three-dimensional virtual space and providing to a terminal the temporal and spatial information for an object selected in the three-dimensional virtual space by the user,
wherein the three-dimensional virtual space and the temporal and spatial information are controlled with reference to a time axis.

3. The method of claim 1, wherein the creating the three-dimensional virtual space is created based on a map or a two-dimensional image.

4. The method of claim 2, wherein the providing the temporal and spatial information provides a historical fact through a simulation.

5. The method of claim 4, wherein the simulation is performed so that the three-dimensional virtual space varies with time in accordance with a time order selected by the user.

6. The method of claim 4, wherein the simulation provides the temporal and spatial information through a three-dimensional character.

7. The method of claim 1, further comprising providing a user with access to the three-dimensional virtual space and providing a user terminal with an interface, with which the temporal and spatial information for an object selected in the virtual space is updated; and
associating the updated temporal and spatial information with the three-dimensional virtual space to store the same in the memory.

8. A system for providing knowledge comprising:
a memory in which a three-dimensional virtual space and temporal and spatial information including knowledge and space information for the three-dimensional virtual space at a specific time point are associated to be stored; and
a controller for controlling the associated three-dimensional virtual space and temporal and spatial information with reference to a time axis, providing a user with access to the three-dimensional virtual space and with the temporal and spatial information for an object selected by the user in the three-dimensional virtual space.

9. The system of claim 8, wherein the three-dimensional virtual space stored in the memory is created based on a map or a two-dimensional image.

10. The system of claim 8, wherein the controller provides a historical fact through a simulation.

11. The system of claim 8, wherein the controller performs the simulation so that the virtual space varies with time in accordance with a time order selected by the user.

12. The system of claim 8, wherein the controller provides the temporal and spatial information to the user through a three-dimensional character.

13. The system of claim 8, further comprising a user terminal for updating the temporal and spatial information for the object selected by the user,
wherein the memory updates and stores the temporal and spatial information input by the user.

14. The system of claim 13, further comprising an authoring tool for providing the user terminal with an interface, with which the user updates the temporal and spatial information.

15. The system of claim 13, further comprising an authoring tool for providing the user terminal with an interface, with which the user creates a new threes dimensional virtual space.
